(19) United States
(12) Patent Application Publication
(10) Pub. No.: US 2007/0029471 A1
(43) Pub. Date: Feb. 8, 2007

(54) Optical beam scanning device and image forming apparatus

(75) Inventor: Masao Yamaguchi, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/197,393

(22) Filed: Aug. 5, 2005

(51) Int. Cl. H01J 3/14

(52) U.S. Cl. 250/234

(57) ABSTRACT

An optical beam scanning device includes a single light deflection device, a pre-deflection optical system which causes a light beam emitted from a light source to be incident to the light deflection device, and a post-deflection optical system which images the light beam, reflected from the light deflection device, onto a scanned surface, wherein the post-deflection optical system has one or a plurality of scanning line bending correction members which are arranged while declined with respect to a central light of the light beam from the light deflection device in a sub-scanning cross section.

### BACKGROUND OF THE INVENTION

The present invention relates to an image forming apparatus such as a laser printer and a digital copying machine and an optical beam scanning device used for the image forming apparatus, particularly to an overillumination scanning optical system whose width in a main scanning direction of incident light flux into a polygon mirror is broader than a plane width in the main scanning direction of the polygon mirror.

An optical beam scanning device is used in the laser printer apparatus, the digital copying machine, and the like which are of an electrostatic copying type image forming apparatus, in which an electrostatic latent image is formed with a laser beam and a visualized (developer) image is obtained by developing the electrostatic latent image. In the optical beam scanning device, the image (original image) to be output is divided into a first direction and a second direction orthogonal to the first direction, and a light beam whose light intensity is changed is repeatedly output in a substantially linear shape at predetermined time intervals based on image data in either the separated first or second direction, i.e., the light beam is scanned. The image corresponding to the original image is obtained by moving a recording medium or a latent image bearing body at constant speed in the direction orthogonal to the scanned light beam during a time interval between the scannings of the one-line light beam and the subsequent one-line light beam or during the scanning of the one line.

In the optical beam scanning device, the first direction in which the light beam is scanned is usually referred to as a main scanning direction. The second direction orthogonal to the first direction is usually referred to as sub-scanning direction. In the image forming apparatus, the sub-scanning direction corresponds to a transfer material conveying direction, and the main scanning direction corresponds to the direction perpendicular to the conveying direction in a transfer material plane. In the image forming apparatus, an image surface corresponds to the transfer material surface, and an imaging surface corresponds to a surface on which the beam is actually imaged.

In the above image forming apparatus and optical beam scanning device, generally the following relationship holds among image process speed (for example, conveying speed of the recording medium such as paper or the latent image bearing body), image resolution, motor revolving speed, and the number of planes of a polygon mirror:

$$P \times R = \frac{25.4 \times Vr \times N}{60} \qquad ( 1 )$$

where
P (mm/s): process speed (sheet conveying speed),
R (dpi): image resolution (the number of dots per inch),
Vr (rpm): the number of revolutions of polygon motor, and
N: the number of planes of polygon mirror.

From the equation (1), it is found that the process speed (namely, print speed) and the image resolution are proportional to the number of planes of the polygon mirror and the number of revolutions of the polygon motor. Therefore, in order to realize speed enhancement and high resolution of the image forming apparatus, it is necessary that the number of planes of the polygon mirror is increased and the number of revolutions of the polygon motor is increased.

In underillumination type (generic term when compared with the overillumination type) optical beam scanning devices which are currently used in many image forming apparatuses, the width (cross-sectional beam diameter, or beam diameter when the main scanning direction differs from the sub-scanning direction in the width) in the main scanning direction of the light beam (light flux) incident to the polygon mirror is limited so as to be smaller than the width in the main scanning direction of an arbitrary reflection plane of the polygon mirror. Accordingly, the light beam guided to each reflection plane of the polygon mirror is entirely reflected by the reflection plane.

On the other hand, the cross-sectional beam diameter (beam diameter in the main scanning direction when the main scanning direction differs from the sub-scanning direction in the diameter) of the light beam guided to the recording medium or the latent image bearing body (image surface) is proportional to an F number Fn of an imaging optical system. At this point, the F number Fn can be expressed by Fn=f/D, where f is a focal distance of the imaging optical system and D is a diameter in the main scanning direction of the light beam in an arbitrary reflection plane of the polygon mirror.

Accordingly, in order to enhance the resolution, when the cross-sectional beam diameter of the light beam is decreased on a scanning subject (image surface), i.e., the recording medium or the latent image bearing body, it is necessary to increase the cross-sectional beam diameter in the main scanning direction in each reflection plane of the polygon mirror. Therefore, when both the plane width of each reflection plane of the polygon mirror and the number of reflection planes are increased, the polygon mirror becomes enlarged. When the large polygon mirror is rotated at high speed, a large motor having a large torque is required, which results in cost increase in the motor, the increases in noise and vibration, and heat generation. Therefore, the countermeasures against these problems are required.

On the contrary, in the overillumination type optical beam scanning device, the width in the main scanning direction of the light beam with which each reflection plane of the polygon mirror is irradiated is set so as to be larger than the width in the main scanning direction of each reflection plane of the polygon mirror, so that the light beam can be reflected by the total plane of each reflection plane. Accordingly, the number of reflection planes of the polygon mirror, the image formation speed, and the image resolution can be increased without increasing the dimension of the polygon mirror, particularly the diameter beyond necessity. Further, in the overillumination type optical beam scanning device, the total diameter of the polygon mirror itself can be decreased, and the number of reflection planes can be increased. Therefore, in the overillumination type optical beam scanning device, a shape of the polygon mirror comes close to a circle and the air resistance is decreased, so that a polygon mirror load is decreased, the noise and the vibration are suppressed, and the heat generation can be suppressed when compared with the underillumination type. Further, since the countermeasure components such as glass required to decrease the noise and vibration can be eliminated or the number of countermeasure components can be decreased, there is also a cost-down effect in the overillumination type optical beam scanning device. Further, a high-duty cycle can be realized. For example, the overillumination scanning optical system is described in Laser Scanning Notebook (Leo Beiser, SPIE OPTICAL ENGINEERING PRESS).

Like the overillumination type, in the optical beam scanning device in which the light beam is incident from a position where an angle is formed between the sub-scanning direction and the reflection plane of the polygon mirror, there is a problem of scanning line bending that a scanning line reflected from the reflection plane of the polygon mirror is curved.

Generally, the imaging optical system in the optical beam scanning device corrects the scanning line bending with a plurality of lenses, the mirror having a curvature, and the like.

However, when the correction is performed with the plurality of optical components, by providing the optical component having negative power in the main scanning direction, an angle of view can be broadened and an optical path length can be shortened. However, the optical path length becomes longer in the configuration in which one imaging lens is used, or in the imaging optical system having only positive power in the main scanning direction. The scanning angle per one plane of the polygon mirror is decreased as the number of planes of the polygon mirror is increased, so that the optical path length becomes longer. Particularly, in the overillumination type optical beam scanning device, the optical path length becomes longer because the number of planes of the polygon mirror is increased.

Thus, the scanning line bending is increased as the optical path length becomes longer. In such the case, it is difficult that the scanning line bending is corrected only with the imaging lens.

### SUMMARY OF THE INVENTION

An object of the invention is to correct the scanning line bending of the light flux scanned by the optical beam scanning means.

An optical beam scanning device of the invention includes a single light deflection device, a pre-deflection optical system which causes a light beam emitted from a light source to be incident to the light deflection device, and a post-deflection optical system which images the light beam, reflected from the light deflection device, onto a scanned surface, wherein the post-deflection optical system has one or a plurality of scanning line bending correction members which are arranged while declined with respect to a central light of the light beam from the light deflection device in a sub-scanning cross section. Therefore, the light flux incident to the scanning line bending correction member is shifted and output from a position different from the incident position, which allows the scanning line bending to be corrected with high accuracy.

An image forming apparatus of the invention includes an optical beam scanning device, a photosensitive body in which an image is formed by a light beam scanned by the optical beam scanning device, and a developing device which develops the image formed on the photosensitive body, wherein the optical beam scanning device includes a single light deflection device, a pre-deflection optical system which causes a light beam emitted from a light source to be incident to the light deflection device, and a post-deflection optical system which images the light beam, reflected from the light deflection device, onto a scanned surface, and the post-deflection optical system has one or a plurality of scanning line bending correction members which are arranged while declined with respect to a central light of the light beam from the light deflection device in a sub-scanning cross section. Therefore, the scanning line bending can be corrected and the image quality can be improved.

### BRIEF DESCRIPTION OF THE DRAWINGS

FIG. 1 is a schematic sectional view of an image forming apparatus having an optical beam scanning device of an embodiment;

FIG. 2 is a schematic diagram showing a configuration of the optical beam scanning device of the embodiment;

FIG. 3 is a schematic block diagram showing a configuration example of a drive circuit in the image forming apparatus of the embodiment;

FIG. 4 is a view showing an amount of scanning line bending when a post-deflection optical system does not exist in the optical beam scanning device;

FIG. 5 is a view explaining a principle of a scanning line bending correction by a correction member of the embodiment;

FIG. 6 is a view showing a relationship between a member inclination angle and the amount of scanning line bending when a refractive index is 1.48 in the correction member of the embodiment;

FIG. 7 is a view showing the relationship between the member inclination angle and the amount of scanning line bending when the refractive index is 1.51 in the correction member of the embodiment;

FIG. 8 is a view showing the relationship between the member inclination angle and the amount of scanning line bending when the refractive index is 1.9 in the correction member of the embodiment; and

FIG. 9 is a view showing the amount of corrected scanning line bending when the correction member of the embodiment is arranged.

### DESCRIPTION OF THE EMBODIMENTS

An embodiment of the invention will be described in detail below with reference to the accompanying drawings.

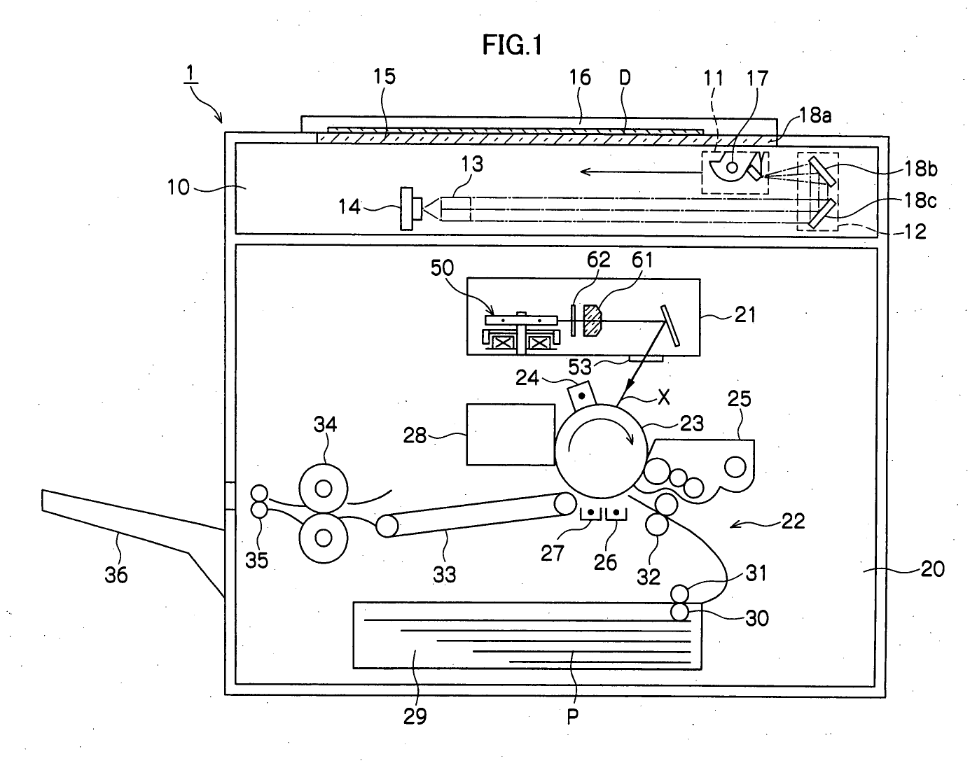

FIG. 1 shows a digital copying machine which is of an image forming apparatus having an optical beam scanning device according to an embodiment of the invention.

As shown in FIG. 1, for example, a digital copying machine 1 has a scanner unit 10 which is of image reading means and a printer unit 20 which is of image forming means.

The scanner unit 10 includes a first carriage 11, a second carriage 12, an optical lens 13, a photoelectric conversion element 14, an original glass plate 15, and an original fixing cover 16. The first carriage 11 is formed while being movable in a narrow direction. The second carriage 12 is moved while driven by the first carriage 11. The optical lens 13 imparts a predetermined imaging property to the light from the second carriage 12. The photoelectric conversion element 14 outputs an electric signal by performing photoelectric conversion of the light to which the predetermined imaging property is imparted by the optical lens 13. The original glass plate 15 holds an original D. The original fixing cover 16 presses the original D against the original glass plate 15.

A light source 17 and a mirror 18a are provided in the first carriage 11. The light source 17 illuminates the original D. The mirror 18a reflects the light reflected from the original D, which is illuminated with the light emitted from the light source 17, toward the second carriage 12.

The second carriage 12 has a mirror 18b and a mirror 18c. The light transmitted from the mirror 18a of the first carriage 11 is folded 90° by the mirror 18b. The light folded by the mirror 18b is further folded 90° by the mirror 18c.

The original D placed on the original glass plate 15 is illuminated by the light source 17, and the light is reflected from the original D. In the reflected light, a variation of light and shade is distributed according to presence or absence of the image. The light reflected from the original D which is of image information on the original D is incident to the optical lens 13 through the mirrors 18a, 18b, and 18c.

The light, reflected from the original D and guided to the optical lens 13, is focused onto a light-reception surface of the photoelectric conversion element (CCD sensor) 14 by the optical lens 13.

When a start of the image formation is input from an operation panel or an external device (not shown), the first carriage 11 and the second carriage 12 are driven by a carriage drive motor (not shown) and tentatively moved to a home position where a predetermined positional relationship is established between the original glass plate 15 and the first and second carriages 11 and 12, and then the first and second carriages 11 and 12 are moved at constant speed along the original glass plate 15. Therefore, the image information on the original D, i.e. the image light reflected from the original D is cut off with a predetermined width along the mirror 18a extending direction, i.e., the main scanning direction, and the image information on the original D is reflected toward the mirror 18b. At the same time, the image information on the original D is sequentially taken out as a unit of the width cut off by the mirror 18a with respect to the direction orthogonal to the mirror 18a extending direction, i.e., the sub-scanning direction, which allows all the pieces of image information on the original D to be guided to the CCD sensor 14. The electric signal output from the CCD sensor 14 is an analog signal, and the analog signal is converted into a digital signal by an A/D converter (not shown) and tentatively stored as the image signal in an image memory (not shown).

Thus, the image in the original D placed on the original glass plate 15 is converted by the CCD sensor 14 into, e.g., the 8-bit digital image signal indicating image density in each line along a first direction in which the mirror 18a extends by an image processing unit (not shown).

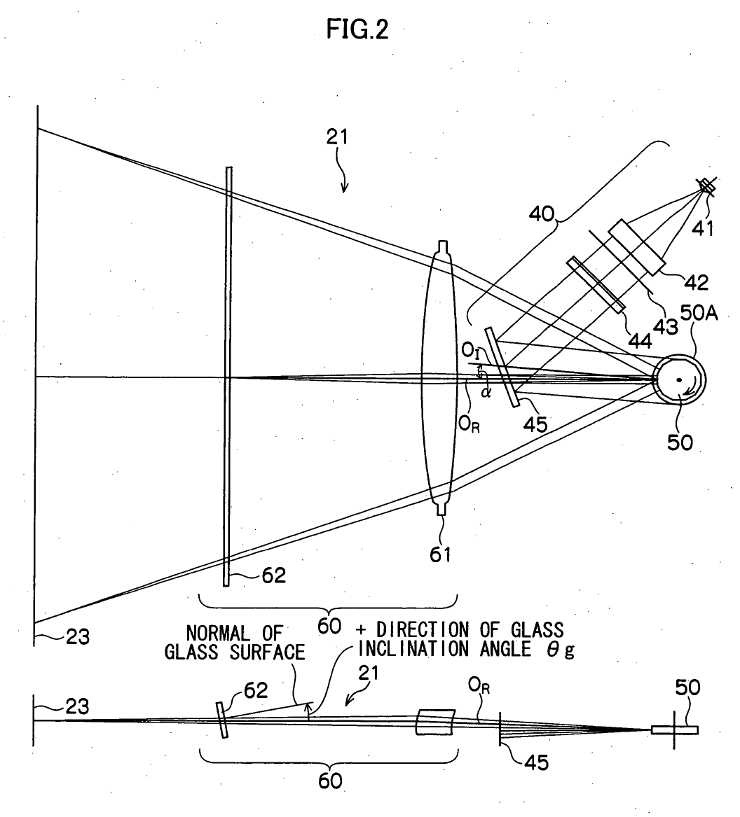

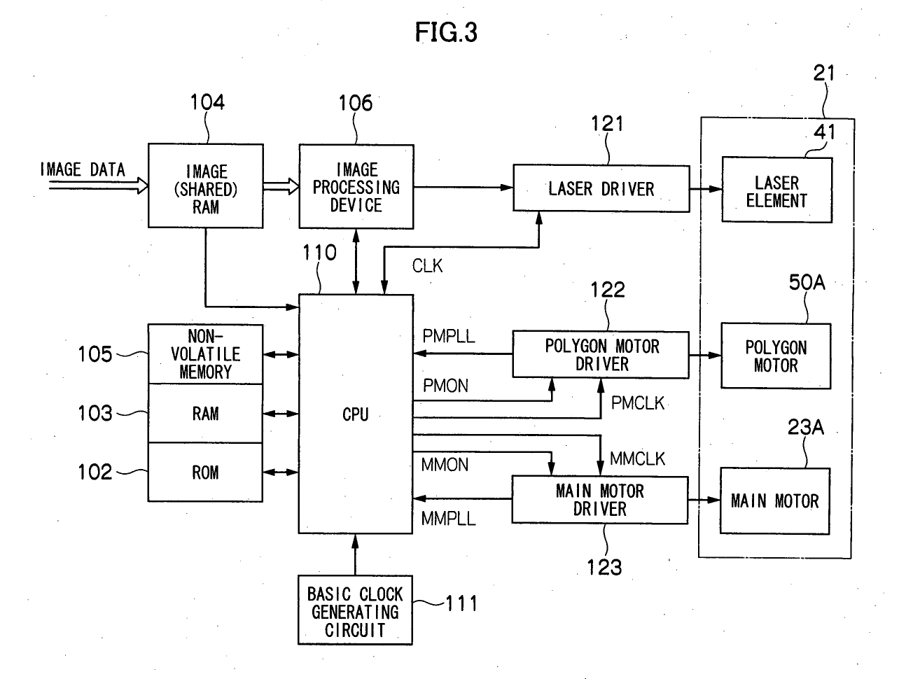

The printer unit 20 includes an optical beam scanning device 21 and an electrophotographic image forming unit 22. The optical beam scanning device 21 is an exposure device which is described later with reference to FIG. 2 and FIG. 3. The image forming unit 22 can form the image on a recording sheet P which is of an image forming medium.

The image forming unit 22 has a drum-shaped photosensitive body (hereinafter referred to as photosensitive drum) 23, a charging device 24, a developing device 25, a transfer device 26, a separation device 27, and a cleaning device 28. The photosensitive drum 23 is rotated by a main motor described later with reference to FIG. 3 such that an outer surface of the photosensitive drum 23 is moved at a constant speed, and an electrostatic latent image corresponding to the image data, i.e., the image of the original D is formed on the photosensitive drum 23 by irradiating the photosensitive drum 23 with a laser beam L from the optical beam scanning device 21. The charging device 24 imparts a surface potential having a predetermined polarity to the surface of the photosensitive drum 23. The developing device 25 performs development by selectively supplying toner of a visualization material to the electrostatic latent image which is formed on the photosensitive drum 23 by the optical beam scanning device. The transfer device 26 transfers the toner image, formed on the outer surface of the photosensitive drum 23 by the developing device 25, to the recording sheet P by imparting a predetermined electric field to the toner image. The separation device 27 separates the toner, located between the recording sheet P to which the toner image has been transferred with the transfer device and the photosensitive drum 23, from the photosensitive drum 23 by releasing the toner from the electrostatic adsorption to the photosensitive drum 23. The cleaning device 28 removes the transfer residual toner remaining on the outer surface of the photosensitive drum 23 to return a potential distribution of the photosensitive drum 23 to the state before the surface potential is supplied with the charging device 24. The charging device 24, the developing device 25, the transfer device 26, the separation device 27, and the cleaning device 28 are arranged in order along an arrow direction in which the photosensitive drum 23 is rotated. A predetermined position X on the photosensitive drum 23 between the charging device 24 and the developing device 25 is irradiated with the laser beam L from the optical beam scanning device 21.

The signal of the image read from the original D with the scanner unit 10 is converted into a print signal through processes such as an outline correction process and a gray level process for half tone display in the image processing unit (not shown). Further, the image signal is converted into a laser modulation signal. In the laser modulation signal, light intensity of the laser beam emitted from the later-mentioned semiconductor laser element of the optical beam scanning device 21 is changed to either the intensity, in which the electrostatic latent image can be recorded on the outer surface of the photosensitive drum 23 to which the predetermined surface potential is imparted with the charging device 24, or the intensity in which the electrostatic latent image is not recorded.

The intensity modulation is performed according to the laser modulation signal in each of the later-mentioned semiconductor laser elements of the optical beam scanning device 21, and the semiconductor laser element emits the light so as to record the electrostatic latent image at a predetermined position of the photosensitive drum 23 corresponding to the predetermined image data. The light beam from the semiconductor laser element is deflected toward the first direction similar to a read line of the scanner unit 10 by the later-mentioned deflection device in the optical beam scanning device 21, and the predetermined position X on the outer surface of the photosensitive drum 23 is irradiated with the light beam.

Then, like the movements along the original plate 7 of the first carriage 11 and the second carriage 12 in the scanner unit 10, the photosensitive drum 23 is rotated at a constant speed in the arrow direction, which allows the outer surface of the photosensitive drum 23 to be exposed in each line at predetermined intervals with the laser beam from the semiconductor laser element sequentially deflected by the deflection device.

Thus, the electrostatic latent image is formed on the outer surface of the photosensitive drum 23 according to the image signal.

The electrostatic latent image formed on the outer surface of the photosensitive drum 23 is developed by the toner from the developing device 25. The developed image is conveyed to a position opposing to the transfer device 26 by the rotation of the photosensitive drum 23, and the developed image is transferred to the recording sheet P by the electric field from the transfer device 26. The one recording sheet P is taken out from a sheet cassette 29 by a sheet feed roller 30 and a separation roller 31, and the recording sheet P is supplied at timing which is adjusted by an aligning roller 32.

The recording sheet P to which the toner image is transferred is separated along with the toner by the separation device 27, and the recording sheet P is guided to a fixing device 34 by the conveying device 33.

In the recording sheet P guided to the fixing device 34, the toner (toner image) is fixed by heat and pressure from the fixing device 34. Then, the recording sheet P is discharged to a tray 36 by a sheet discharge roller 35.

On the other hand, after the toner (toner image) is transferred to the recording sheet P by the transfer device 26, the photosensitive drum 23 opposes to the cleaning device 28 as a result of the continuous rotation, the transfer residual toner (remaining toner) on the outer surface is removed, and the photosensitive drum 23 is returned to the initial state before the surface potential is supplied with the charging device 24, which enables the next image formation.

The continuous image formation operation can be performed by repeating the above processes.

Thus, in the original D set in the original glass plate 15, the image information is read with the scanner unit 10, and the read image information is converted into the toner image and output to the recording sheet P with the printer unit 20, which allows the copy to be made.

In the above image forming apparatus, the digital copying machine is described by way of example. For example, the invention can be applied to the printer apparatus with no image reading unit.

Then, a detailed configuration of the optical beam scanning device 21 shown in FIG. 1 will be described with reference to FIG. 2.

FIG. 2 is a schematic diagram explaining the configuration of the optical beam scanning device 21 shown in FIG. 1. FIG. 2A is a schematic plan view when the folding by the mirror is developed while optical elements arranged between the light source (semiconductor laser element) and the photosensitive drum (scanning subject) which are included in the optical beam scanning device 21 are viewed from the direction orthogonal to the main scanning direction (first direction), which is parallel to the direction in which the light beam from the light deflection device (polygon mirror) toward the photosensitive drum is scanned by the light deflection device. FIG. 2B is a schematic sectional view in which the sub-scanning direction (second direction) orthogonal to the direction shown in FIG. 2, i.e., the main scanning direction becomes a plane.

As shown in FIG. 2A and FIG. 2B, the optical beam scanning device 21 has a pre-deflection optical system 40. The pre-deflection optical system 40 includes a semiconductor laser element (light source) 41, a lens 42, an aperture 43, a cylindrical lens 44, and a mirror 45. The semiconductor laser element 41 emits the laser beam (light beam) L having, e.g., a wavelength of 780 nm. The lens 42 converts a cross-sectional beam shape of the laser beam L emitted from the semiconductor laser element 41 into a focused light beam, a parallel light beam, or a divergent light beam. The aperture 43 limits a light quantity (light flux width) of the laser beam L transmitted through the lens 42 to a predetermined size. Positive power is imparted to the cylindrical lens 44 only in the sub-scanning direction in order to arrange the cross-sectional beam shape of the laser beam L, in which the light quantity is limited by the aperture 43, in a predetermined cross-sectional beam shape. The mirror 45 folds the laser beam L, in which the cross-sectional shape is arranged in the predetermined cross-sectional beam shape by the finite focal point lens or collimate lens 42, the aperture 43, and the cylindrical lens 44, from the semiconductor laser element 41 toward the predetermined direction.

A polygon mirror (light deflection device) 50 is provided in the direction in which the laser beam L, to which the predetermined cross-sectional beam shape is imparted by the pre-deflection optical system 40, progresses. The polygon mirror 50 is integrated with a polygon mirror motor 50A rotated at constant speed. The polygon mirror 50 scans the laser beam L, in which the cross-sectional beam shape is arranged in the predetermined shape by the cylindrical lens 44, toward the photosensitive drum (scanned surface) 23 located in a post-step.

An imaging optical system 60 is provided between the polygon mirror 50 and the photosensitive drum 23. The imaging optical system 60 images the laser beam L, continuously reflected from the reflection planes of the polygon mirror 50, in a substantially linear shape along an axial line direction of the photosensitive drum 23.

The imaging optical system 60 includes an imaging lens (usually referred to as fθ lens) 61 and a scanning line bending correction member 62. The imaging lens 61 irradiates one end to the other end in a longitudinal direction (axial line) of the photosensitive drum 23 at the exposure position X shown in FIG. 1 with the laser beam L continuously reflected from the reflection planes of the polygon mirror 50 while the position on the photosensitive drum 23 is proportioned to a rotating angle of each reflection plane of the polygon mirror 50 in irradiating the photosensitive drum 23. The imaging lens 61 can provide a convergent property in which a predetermined correlation is given based on the rotated angle of the polygon mirror 50 such that a predetermined cross-sectional beam diameter is obtained at any position in the longitudinal direction on the photosensitive drum 23. The scanning line bending correction member 62 corrects the scanning line bending of the light beam continuously reflected from the reflection planes of the polygon mirror 50.

At this point, there is shown the case in which dust-proof glass is used as the correction member 62 in the optical beam scanning device 21 of the embodiment shown in FIG. 2. The dust-proof glass prevents the toner, duct, paper dust, and the like, which are suspended in the image forming unit 22, from running around into a housing (not shown) in the image forming unit 22. In the following description, the one plate of dust-proof glass is used as the correction member 62. However, the correction member 62 is not limited to the number of plates of dust-proof glass as long as the dust-proof glass can effectively correct the scanning line bending, and the plurality of plates of dust-proof glass may be used. Parallel plate glass can be applied to the scanning line bending correction member 62, and the scanning line bending correction member 62 may be made of plastic.

An optical path of the laser beam L from the laser element 41 in the optical beam scanning device 21 to the photosensitive drum 23 is folded by the plurality of mirrors (not shown) and the like in the housing (not shown) of the optical beam scanning device 21. The imaging lens 61 and at least one of the mirrors (not shown) may integrally be formed by optimizing curvatures in the main scanning direction and sub-scanning direction of the imaging lens 61 and the optical path between the polygon mirror 50 and the photosensitive drum 23.

In the optical beam scanning device 21 shown in FIG. 2A, an angle α formed by an axis O_{I} and an optical axis O_{R} of the imaging optical system 60 is 5° when the axis O_{I} and the optical axis O_{R} are projected onto the main scanning plane, where the axis O_{I} is located along a principal ray of the incident laser beam orientated toward each reflection plane of the polygon mirror 50. A scanning angle β is 26.426°. Referring to FIG. 2B, an angle formed by the axis O_{I} of the principal ray of the incident laser beam and the optical axis O_{R} of the imaging optical system 60 is 2° when viewed from the sub-scanning cross-section of the axis O_{I} and the optical axis O_{R}.

The optical beam scanning device 21 shown in FIG. 2 is driven by a drive circuit of the digital copying machine 1 as shown in FIG. 3. FIG. 3 is a schematic block diagram showing an example of the drive circuit of the digital copying machine including the optical beam scanning device shown in FIG. 2.

A ROM (Read Only Memory) 102, a RAM 103, a shared (image) RAM 104, an NVM (Non-Volatile Memory) 105, an image processing device 106, and the like are connected to a CPU 110 which is of a main control device. A predetermined operating rule and initial data are stored in the ROM 102. Inputted control data is tentatively stored in the RAM 103. While the shared RAM 104 holds the image data from the CCD sensor 14 or the image data supplied from the external device, the shared RAM 104 outputs the image data to an image processing circuit shown below. The NVM 105 can hold the pieces of data stored until that time by battery backup even if the passage of electric current through the digital copying machine 1 is interrupted. The image processing device 106 performs predetermined image processing to the image data stored in the image RAM 104, and the image processing device 106 outputs the image data to a laser driver described below.

A laser driver 121, a polygon motor driver 122, a main motor driver 123, and the like are also connected to the CPU 110. The laser driver 121 emits the semiconductor laser element 41 in the optical beam scanning device 21. The polygon motor driver 122 drives the polygon motor 50A which rotates the polygon mirror 50. The main motor driver 123 drives a main motor 23A for driving the photosensitive drum 23, a conveying mechanism of the attendant recording sheet (transferred material), and the like.

In the optical beam scanning device 21 shown in FIG. 2, the divergent laser beam L, emitted from the laser element 41, whose cross-sectional beam shape is converted into the focusing light, the parallel light, or the divergent light by the lens 42 under the drive control by the drive circuit shown in FIG. 3.

The laser beam L whose cross-sectional beam shape is converted into the predetermined shape is passed through the aperture 43 to optimally set the light flux width and the light quantity, and a predetermined convergent property is imparted in the sub-scanning direction by the cylindrical lens 44. Therefore, the laser beam L becomes the linear shape which is extended in the main scanning direction on each reflection plane of the polygon mirror 50.

For example, the polygon mirror 50 is a regular dodecahedron, and the polygon mirror 50 is formed such that an inscribed circle diameter Dp of the regular dodecahedron is set at 29 mm. Assuming that the number of reflection planes of the polygon mirror 50 is N, a width Wp in the main scanning direction of each reflection plane (twelve planes) of the polygon mirror 50 can be determined from the following equation:
Wp=tan(π/N)×Dp (2)
In this case,
Wp=tan(π/12)×29=7.77 mm (3)

On the other hand, a beam width D_{L} in the main scanning direction of the laser beam L with which each plane of the polygon mirror 50 is irradiated is substantially 32 mm, and the beam width DL is set broader when compared with the width Wp=7.77 mm in the main scanning direction of each reflection plane of the polygon mirror 50. As the beam width becomes broader in the main scanning direction, a variation in light quantity is decreased at a scanning end and a scanning center in an image surface.

In the laser beam L, which is guided to each reflection plane of the polygon mirror 50 and scanned (deflected) in linear by the continuous reflection by the rotation of the polygon mirror 50, a predetermined imaging property is imparted by the imaging lens 61 of the imaging optical system 60 such that the cross-sectional beam diameter becomes substantially even with respect to the main scanning direction on the photosensitive drum 23 (image surface). Then, the laser beam L is imaged in the substantially linear shape on the surface of the photosensitive drum 23.

The correction is performed by the imaging lens 61 such that a proportional relationship holds between the rotation angle of each reflection plane of the polygon mirror 50 and the imaging position, i.e. the scanning position of the light beam imaged on the photosensitive drum 23. Accordingly, the speed of the laser beam linearly scanned on the photosensitive drum 23 by the imaging lens 61 becomes constant in all the scanning areas. The curvature (sub-scanning direction curvature) which can correct the scanning position shift in the sub-scanning direction is imparted to the imaging lens 61. The scanning position shift is caused by non-parallelism of the reflection planes of the polygon mirror 50 in the sub-scanning direction, i.e., generation of slants of the reflection planes.

The imaging lens 61 also corrects a curvature of field in the sub-scanning direction. In order to correct these optical properties, the curvature in the sub-scanning direction is changed according to the scanning position.

At this point, the shape of the lens surface of the imaging lens 61 is defined by, e.g., TABLE 1 and Equation (4).

TABLE 1

| | |
|---|---|
| | (4) |
| $x = \frac{CUY * {y}^{2} + CUZ * {z}^{2}}{\begin{matrix}1 + \\ \sqrt{1 - AY * {CUY}^{2} * - {y}^{2} - AZ * - {CUZ}^{2} * {z}^{2}}\end{matrix}} + {\sum }_{n - 0} {\sum }_{m - 01} {A}_{mn} {y}^{m} {z}^{2 n}$ | |

where y indicates the main scanning direction, z indicates the sub-scanning direction, and x indicates the optical axis direction.

A rotation angle θof each reflection plane of the polygon mirror 50 is substantially proportioned to the position of the laser beam L imaged on the photosensitive drum 23 with the imaging lens 61, so that the position of the laser beam L can be corrected in imaging the laser beam L on the photosensitive drum 23.

Further, the imaging lens 61 can correct the position shift in the sub-scanning direction, which is caused by an inclination deviation in the sub-scanning direction, i.e., the variation in slant amount of the reflection planes of the polygon mirror 50. Specifically, in a laser beam incident plane (polygon mirror 50 side) and an outgoing plane (photosensitive drum 23 side) of the imaging lens 61, even if gradients defined between an arbitrary reflection plane of the polygon mirror 50 and the rotation axis of the polygon mirror 50 differ from one another (the gradient is different in each reflection plane), the scanning position shift in the sub-scanning direction of the laser beam L guided onto the photosensitive drum 23 can be corrected by substantially forming an optically conjugate relationship.

The cross-sectional beam diameter of the laser beam L depends on the wavelength of the laser beam L emitted from the semiconductor laser element 41. Therefore, the wavelength of the laser beam L is set at 650 nm or 630 nm, or a shorter wavelength, which allows the cross-sectional beam diameter of the laser beam L to be further decreased.

The post-deflection mirror is formed by a flat plane. That is, the plane slant correction is performed only by the imaging lens 61.

The lens which has a rotational symmetry axis with respect to the main scanning axis and in which the curvature in the sub-scanning direction is changed by the scanning position, e.g., a toric lens may be used in the surface shape of the imaging lens. Therefore, the scanning position is changed by refracting power in the sub-scanning direction, which allows the scanning line bending to be corrected. Cyclic olefin resin is used as the material of the imaging lens 61.

In the laser beam outgoing from the imaging lens 61, the scanning line bending is corrected by the scanning line bending correction member 62. The scanning line bending correction member 62 is obliquely arranged so as to increase the angle formed between the sub-scanning direction light reflected from each reflection plane of the polygon mirror 50 and the normal of the correction member 62. Therefore, the scanning line bending can be decreased.

The reason why the scanning line bending correction member 62 is provided behind the imaging lens 61 like the embodiment will be described below.

Usually the imaging optical system 60 is the optical components such as the plurality of lenses and the mirror having the curvature, and the imaging optical system 60 has the action such as the evenness of the beam diameter, the image surface curvature correction, securement of the fθ property, the scanning line bending correction, and the plane slant correction in all the scanning areas. When the correction is performed with the plurality of optical components, the angle of view can be widened and the optical path length can be shortened by providing the optical component having the negative power in the main scanning direction. On the other hand, the optical path length becomes longer in the configuration in which the one imaging lens 61 is used, or in the imaging optical system having only the positive power in the main scanning direction. The scanning angle per one plane of the polygon mirror is decreased as the number of planes of the polygon mirror is increased, so that the optical path length becomes longer. Particularly, in the overillumination optical system, the optical path length becomes longer because the number of planes of the polygon mirror is increased.

For example, as shown in FIG. 2B, the light beam incident to the polygon mirror 50 is caused to be incident from the position having the gradient with respect to the reflection plane. Therefore, the scanning line is curved by the light beam reflected from the polygon mirror 50, and the scanning line bending is further increased when the optical path length is lengthened.

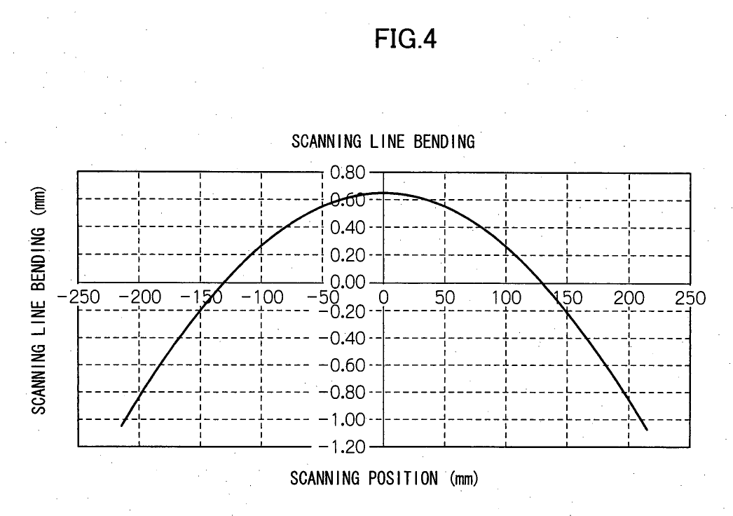

FIG. 4 is a view showing the scanning line bending in all the scanning positions when no optical component is provided in the imaging optical system 60 in the optical beam scanning device 21 shown in FIG. 2. As shown in FIG. 4, when no optical component is provided in the imaging optical system 60, it is found that a bending amount (peak-to-peak amount) is not lower than 1.6 mm in the light beam from the polygon mirror 50. It is difficult such the large bending amount is corrected only with the imaging lens.

Therefore, the correction member 62 is arranged behind the imaging lens 61 and inclined so as to increase the angle formed between the sub-scanning direction light reflected from the polygon mirror 50 and the normal direction of the correction member 62, which allows the scanning line bending amount to be decreased.

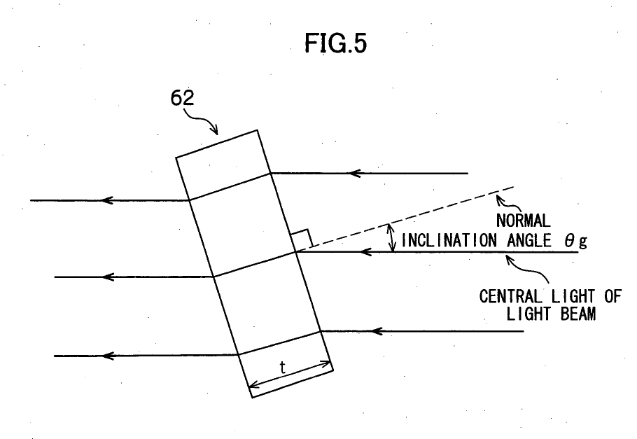

That is, as shown in FIG. 5, the light beam positions of the incident plane and the outgoing plane in the member can be shifted by obliquely providing the scanning line bending correction member 62, so that the scanning line bending can be decreased.

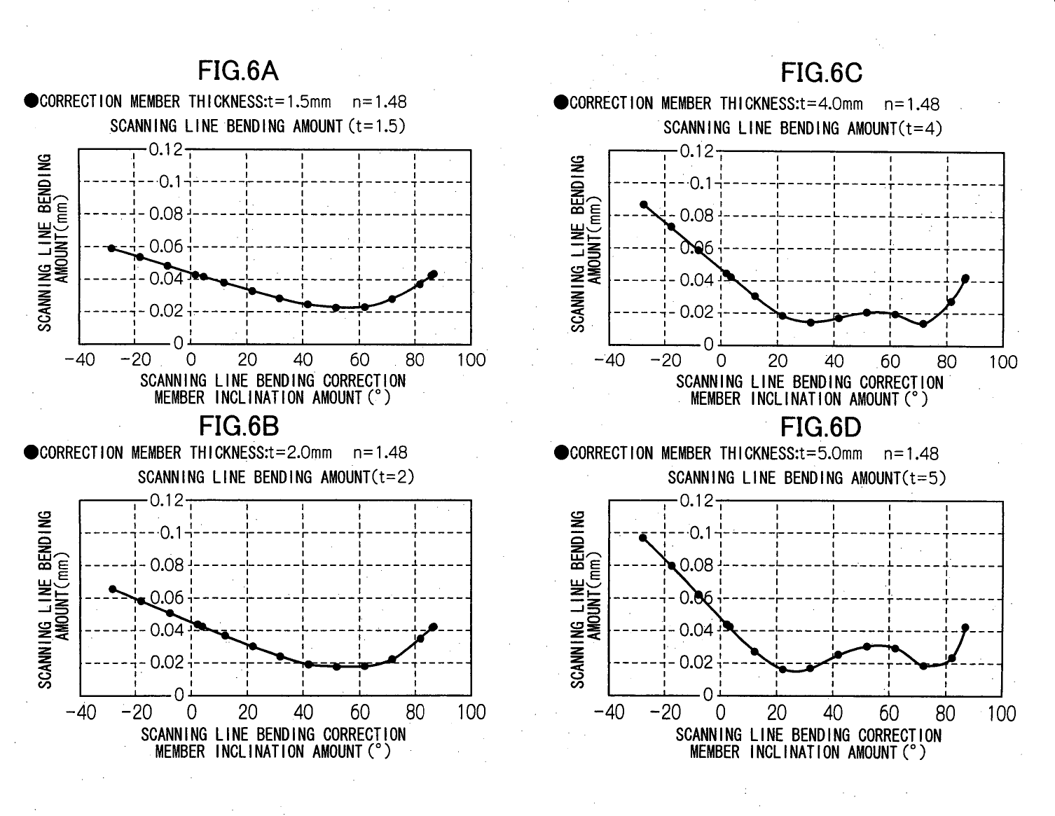

FIG. 6 to FIG. 8 show simulation results of the scanning line bending amount when the inclination angle θg of the scanning line bending correction member 62 and a thickness t of the correction member 62 are changed.

The following simulations are performed with the optical beam scanning device 21 having the configuration shown in FIG. 2. As shown in TABLE 3, the conditions are set as follows. The distance between the polygon mirror reflection plane and the image surface is set at 428.8374 mm, the distance between the polygon mirror reflection plane and the incident plane of the fθ lens (imaging lens) is set at 133.3742 mm, the distance between the polygon mirror reflection plane and the incident plane of the correction member is set at 255.9364 mm, the light beam angle (sub-scanning cross section) is set at 2° after the light beam is reflected from the polygon mirror, and the light beam angle (sub-scanning cross section) is set at 0.7840° after the light beam is output from fθ lens.

TABLE 3

| | | |
|---|---|---|
| Distance between polygon mirror reflection plane | 428.8374 | mm |
| and image surface | | |
| Distance between polygon mirror reflection plane | 133.3742 | mm |
| and imaging lens incident plane | | |
| Distance between polygon mirror reflection plane | 255.9364 | mm |
| and correction member incident plane | | |
| Light beam angle (sub-scanning cross section) after | 2° | |
| light beam is reflected from polygon mirror | | |
| Light beam angle (sub-scanning cross section) after | 0.7840° | |
| light beam is output from imaging lens | | |

In consideration of cost and shape accuracy, it is practical that the refractive index n of the correction member 62 ranges from 1.48 (PMMA) to 1.9 (PBH71: product of OHARA INC.), and the simulation should be performed in the above range.

Referring to FIG. 6, the scanning line bending correction member 62 is formed by the parallel plate glass whose refractive index n is 1.48, and the results of the scanning line bending amount are determined by the simulation for each of the thicknesses t of 1.5 mm, 2 mm, 4 mm, and 5 mm when the inclination angle θg of the correction member 62 is changed. In this case, the thickness of the correction member 62 practically ranges from 1.5 mm to 5 mm in consideration of the cost and the shape accuracy, so that the simulation is performed in this range.

As can be seen from FIG. 6, when θg becomes positive, the scanning line bending amount is decreased. At this point, in an allowance of the scanning line bending, the image deterioration cannot be recognized when the scanning line bending is not more than one (1) dot interval (42.3 μm) of 600 dpi. In FIG. 6, it is found that the inclination angle θg of the correction member in which the scanning line bending becomes 42.3 μm can be in the range of 4.5846<θg<86.2755 when the thickness of the correction member ranges from 1.5 mm to 5 mm.

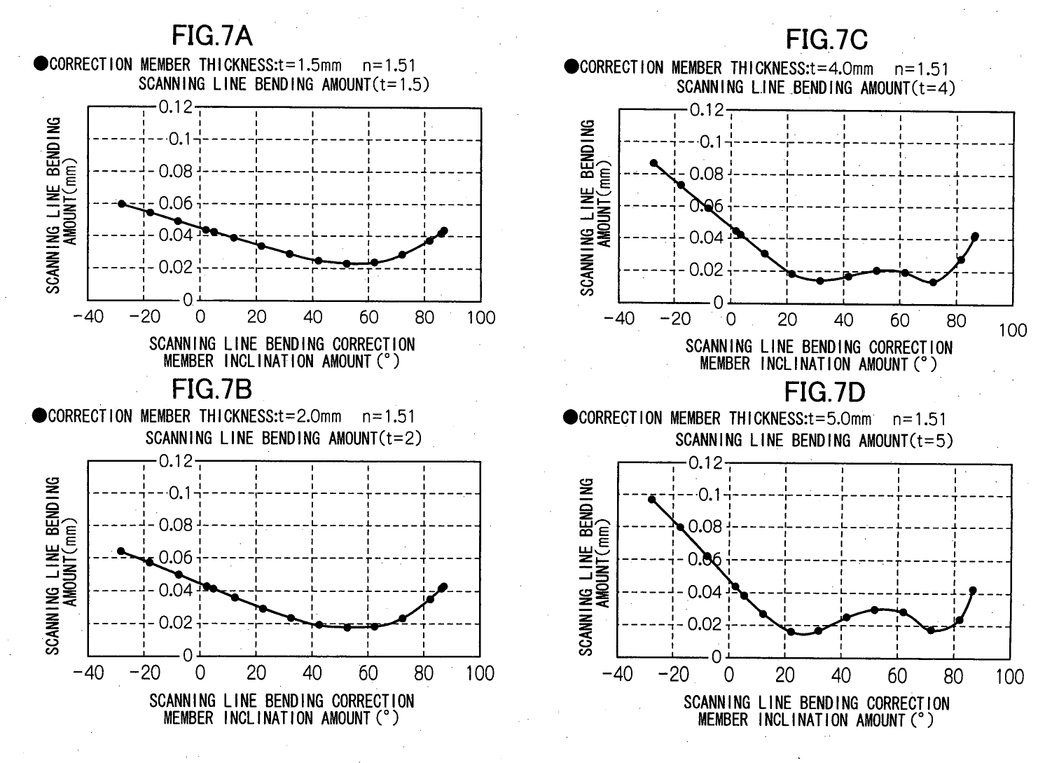

Referring to FIG. 7, the scanning line bending correction member 62 is formed by the parallel plate glass whose refractive index n is 1.51, and the results of the scanning line bending amount are determined by the simulation for each of the thicknesses t of 1.5 mm, 2 mm, 4 mm, and 5 mm when the inclination angle θg of the correction member 62 is changed.

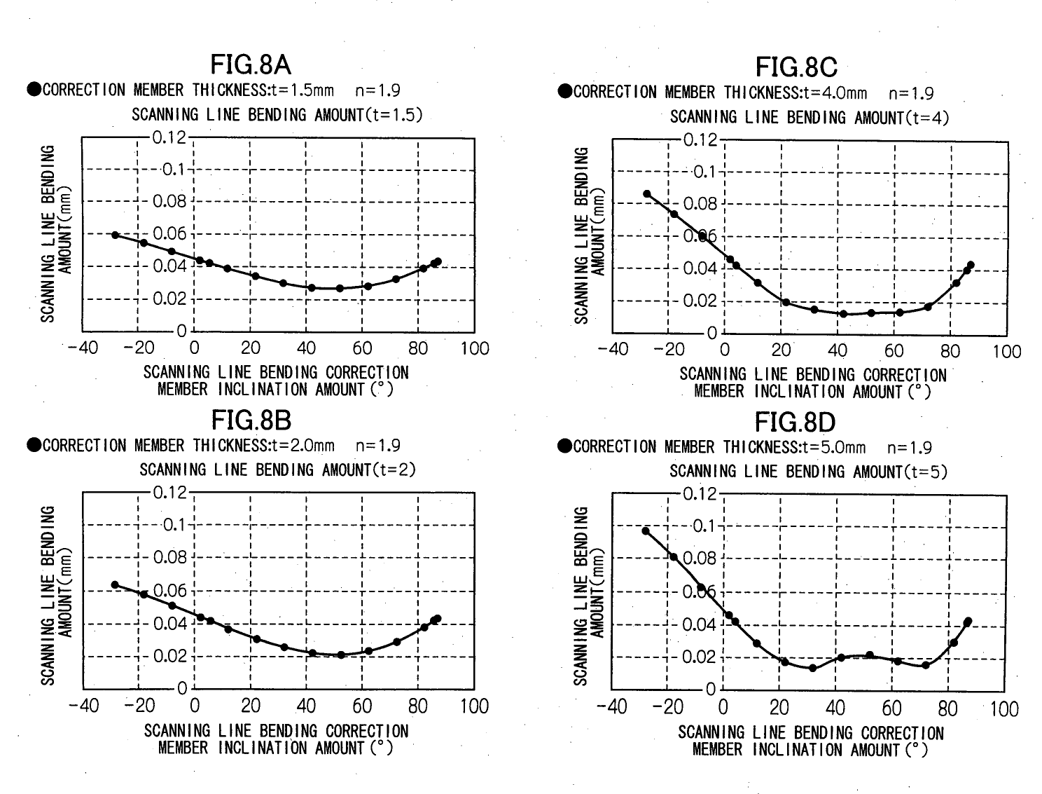

Referring to FIG. 8, the scanning line bending correction member 62 is formed by the parallel plate glass whose refractive index n is 1.9, and the results of the scanning line bending amount are determined by the simulation for each of the thicknesses t of 1.5 mm, 2 mm, 4 mm, and 5 mm when the inclination angle θg of the correction member 62 is changed.

TABLE 2 is the summary of the simulation results of FIG. 6 to FIG. 8, and TABLE 2 is the summary in each thickness for the range where the scanning line bending amount is not more than 42.3 μm. θg which satisfies all the conditions of TABLE 2 is in the range of 5.549°<θg<85.668°. When θg satisfies the conditions, the scanning line bending amount is decreased and the image quality can be improved.

TABLE 2A

| Refractive index n = 1.48 | |
|---|---|
| Correction member thickness (mm) | Inclination angle range (°) |
| 1.5 | 4.5845 to 86.2755 |
| 2 | 4.0465 to 86.5098 |
| 4 | 3.2405 to 86.8589 |
| 5 | 3.0794 to 86.9291 |

TABLE 2B

| Refractive index n = 1.510 | |
|---|---|
| Correction member thickness (mm) | Inclination angle range (°) |
| 1.5 | 4.6626-86.1448 |
| 2 | 4.1650-86.4429 |
| 4 | 3.3635-86.8030 |
| 5 | 5.1926-86.9034 |

TABLE 2C

| Refractive index n = 1.9 | |
|---|---|
| Correction member thickness (mm) | Inclination angle range (°) |
| 1.5 | 5.5494-85.6689 |
| 2 | 5.0111-86.0230 |
| 4 | 4.2192-86.5527 |
| 5 | 4.0609-86.6587 |

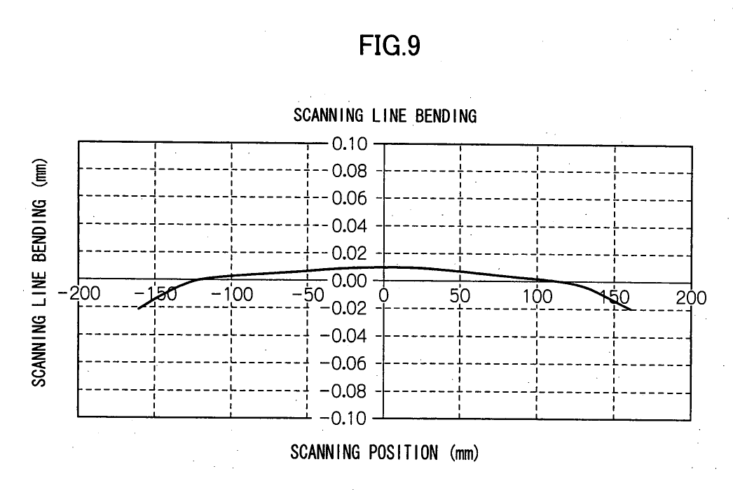

FIG. 9 shows the scanning line bending amount in which θg is inclined 12.96° on the conditions that the thickness of the correction member 62 is set at 2 mm and the refractive index is set at 1.51.

The scanning line bending amount is as small as about 31 μm, and the good image quality is obtained. In the embodiment, the parallel flat plate is cited as an example of the scanning line bending correction member. However, the correction effect can be exerted even if the scanning line bending correction member is not parallel. For example, in a prism, the incident position and the outgoing position of the member are shifted to change the angle, so that the scanning line bending can be corrected.

The plurality of scanning line bending correction members exhibit the larger effect when compared with the single scanning line bending correction member.

TABLE 1
INCIDENT PLANE

| CUY | CYZ | AY | AZ |
|---|---|---|---|
| −6.19E−03 | −7.12E−03 | 1 | 1 |

| | | m | | | | | |
|---|---|---|---|---|---|---|---|
| | | 0 | 1 | 2 | 3 | 4 | 5 |
| n | 0 | 0.00E+00 | −1.54E−03 | 1.84E−03 | −2.07E−07 | 1.18E−07 | 5.92E−12 |
| | 1 | 1.34E−02 | −1.25E−06 | −2.09E−07 | −1.37E−10 | 1.11E−10 | −5.79E−14 |
| | 2 | 2.26E−05 | −1.73E−09 | 4.67E−11 | 3.62E−12 | −1.18E−13 | −1.23E−15 |

m

| | | 6 | 7 | 8 | 9 | 10 |
|---|---|---|---|---|---|---|
| n | 0 | −5.89E−12 | −2.33E−15 | 3.31E−16 | −1.28E−19 | −1.93E−20 |
| | 1 | −8.30E−15 | −1.04E−17 | 4.72E−19 | 1.31E−21 | 2.24E−23 |
| | 2 | 2.14E−17 | −3.94E−21 | 8.65E−21 | 1.92E−23 | −1.93E−25 |

OUTGOING PLANE

| CUY | CYZ | AY | AZ |
|---|---|---|---|
| 3.28E−03 | 2.76E−02 | 1 | 1 |

| | | m | | | | | |
|---|---|---|---|---|---|---|---|
| | | 0 | 1 | 2 | 3 | 4 | 5 |
| n | 0 | 0.00E+00 | −1.69E−03 | −9.88E−04 | −1.85E−07 | 6.45E−08 | −6.44E−12 |
| | 1 | 3.37E−03 | −7.72E−07 | −4.14E−07 | −2.46E−10 | 6.75E−11 | 2.42E−14 |
| | 2 | 5.30E−06 | 7.69E−10 | 4.85E−10 | 2.42E−13 | 1.44E−13 | 1.32E−16 |

| | m | | | | | |
|---|---|---|---|---|---|---|
| | | 6 | 7 | 8 | 9 | 10 |
| n | 0 | −3.12E−12 | 3.44E−16 | 1.40E−16 | −3.37E−19 | −1.74E−20 |
| | 1 | −1.50E−15 | −1.30E−17 | −1.04E−19 | 3.36E−22 | 4.27E−23 |
| | 2 | −2.28E−17 | −1.32E−19 | 3.18E−21 | 1.54E−23 | 3.40E−25 |

What is claimed is:

1. An optical beam scanning device comprising:
a light deflection device;
a pre-deflection optical system which causes a light beam emitted from a light source to be incident to the light deflection device; and
a post-deflection optical system which images the light beam, reflected from the light deflection device, onto a scanned surface,
wherein the post-deflection optical system has one or a plurality of scanning line bending correction members which are arranged while declined with respect to a central light of the light beam from the light deflection device in a sub-scanning cross section.

2. An optical beam scanning device according to claim 1, wherein the post-deflection optical system has one or a plurality of optical components which exert positive power in a main scanning direction, and said each scanning line bending correction member is arranged behind the optical component.

3. An optical beam scanning device according to claim 2, wherein said each scanning line bending correction member is a parallel flat plate.

4. An optical beam scanning device according to claim 3, wherein a refractive index n of the scanning line bending correction member ranges from 1.48≦n≦1.9.

5. An optical beam scanning device according to claim 4, wherein an inclination angle θg of the scanning line bending correction member, which is formed by a normal perpendicular to a flat plate surface of the scanning line bending correction member and the central light of the light beam from the light beam from the light deflection device in the sub-scanning cross section, satisfies the following expression
5.549°<θg<85.668°.

6. An optical beam scanning device according to claim 5, wherein the optical component which exerts the positive power in the main scanning direction is a single lens.

7. An optical beam scanning device according to claim 6, wherein a width in the main scanning direction of light flux of the light beam incident to the light deflection device is broader than a width in the main scanning direction of a single reflection plane of the light deflection device.

8. An optical beam scanning device according to claim 7, wherein a curvature in a sub-scanning direction at a position, through which the light beam of the optical component is passed, is different by a scanning position.

9. An image forming apparatus comprising an optical beam scanning device, a photosensitive body in which an image is formed by a light beam scanned by the optical beam scanning device, and a developing device which develops the image formed on the photosensitive body,
wherein the optical beam scanning device includes:
a light deflection device;
a pre-deflection optical system which causes a light beam emitted from a light source to be incident to the light deflection device; and
a post-deflection optical system which images the light beam, reflected from the light deflection device, onto a scanned surface, and
the post-deflection optical system has one or a plurality of scanning line bending correction members which are arranged while declined with respect to a central light of the light beam from the light deflection device in a sub-scanning cross section.

10. An image forming apparatus according to claim 9, wherein the post-deflection optical system has one or a plurality of optical components which exert positive power in a main scanning direction, and said each scanning line bending correction member is arranged behind the optical component.

11. An image forming apparatus according to claim 10, wherein said each scanning line bending correction member is a parallel flat plate.

12. An image forming apparatus according to claim 11, wherein a refractive index n of the scanning line bending correction member ranges from 1.48<n<1.9.

13. An image forming apparatus according to claim 12, wherein an inclination angle θg of the scanning line bending correction member, which is formed by a normal perpendicular to a flat plate surface of the scanning line bending correction member and the central light of the light beam from the light beam from the light deflection device in the sub-scanning cross section, satisfies the following expression
5.549°<θg<85.668°.

14. An image forming apparatus according to claim 13, wherein the optical component which exerts the positive power in the main scanning direction is a single lens.

15. An image forming apparatus according to claim 14, wherein a width in the main scanning direction of light flux of the light beam incident to the light deflection device is broader than a width in the main scanning direction of a single reflection plane of the light deflection device.

16. An image forming apparatus according to claim 15, wherein a curvature in a sub-scanning direction at a position, through which the light beam of the optical component is passed, is different by a scanning position.
